(19) United States
(12) Patent Application Publication
(10) Pub. No.: US 2015/0274227 A1
(43) Pub. Date: Oct. 1, 2015

(54) Vehicle-mounted Traction Apparatus

(71) Applicant: Mubarak Aljahmi, Brooklyn, NY (US)

(72) Inventor: Mubarak Aljahmi, Brooklyn, NY (US)

(21) Appl. No.: 14/225,606

(22) Filed: Mar. 26, 2014

(51) Int. Cl. B62D 55/04; B62D 55/02

(52) U.S. Cl. CPC B62D 55/04; B62D 55/02

(57) ABSTRACT

Embodiments of the disclosed technology are directed to methods and/or apparatuses for propelling a vehicle over difficult terrain, using a tracked-belt wheel assembly that is adjustably extendable from an under body of the vehicle. The tracked-belt wheel assembly may be driven by the same rotational force used to turn the drive-axle of the vehicle. A switch-controlled actuating feature may be used to raise and/or lower the wheel assembly, using one or more hydraulic cylinders. The switch may toggle between different operating modes of the wheel assembly which correspond to different levels of extension with respect to the driving surface and/or the tires of the vehicle. The tracked-belt may additionally have adjustable spikes or studs for further engaging a driving surface.

### FIELD OF THE DISCLOSED TECHNOLOGY

The disclosed technology relates generally to motor vehicles and, more particularly, to an apparatus for providing additional traction and/or propulsion to a vehicle traversing difficult terrain.

### BACKGROUND OF THE DISCLOSED TECHNOLOGY

A majority of the vehicles on the road today are not equipped with four-wheel drive or all-wheel drive systems. These vehicles are typically propelled by either the two front wheels or the two rear wheels. As a result, hazardous driving surface conditions, such as snow or sand, often result in a two-wheel drive vehicle getting stuck. Thus, many drivers refrain from using their vehicles during icy or snowy conditions, or over slippery or loose terrain.

While a four-wheel drive vehicle such as a sport-utility vehicle (SUV) or a truck may eliminate such problems, these vehicles may be impractical for many drivers, due to rising gas prices and size limitations. Furthermore, those living in a geographical location that experiences snowfall on only a limited number of days in a given year may not want to invest in such a vehicle, since the four-wheel drive feature will only be used occasionally.

Thus, needed in the art are apparatuses and methods for providing traction and additional propulsion to any type of vehicle only in times of need.

### SUMMARY OF THE DISCLOSED TECHNOLOGY

Therefore, it is an object of the disclosed technology to provide an under-body propulsion assembly and method to be used on a vehicle for engaging a loose or slippery road surface.

In an embodiment of the disclosed technology, an apparatus is used for propelling a vehicle. The vehicle has at least one axle with a differential unit and tires disposed at ends thereof. The apparatus has a circuitous tracked-belt disposed around at least two drive-wheels. Further, the apparatus has at least one hydraulic cylinder extending between the drive-wheels and the axle of the vehicle, a length of the hydraulic cylinder being adjustable to raise or lower the drive-wheels. An adjustable drive-arm extends between the drive-wheels and the differential. The drive-wheels are rotatable by translational rotational power provided by the differential unit.

The apparatus may also have a switch for controlling the raising and lowering of the hydraulic cylinder. Still further, spikes may extend from the drive-wheels. The spikes may be adjustably extendable from the drive-wheels to engage a driving surface. Additionally, the spikes may be controlled by a switch. In embodiments, the circuitous tracked-belt is disposed within approximately twelve inches of the tire of the vehicle, such that lowering of the tracked-belt raises the tire off a driving surface.

The apparatus may be switched between three modes. The modes may include: 1) a first mode, wherein the tracked-belt is pressed sufficiently against a driving surface, such that the tire is lifted off the driving surface; 2) a second mode, wherein the tracked-belt is engaged to the driving surface, such that the tire is still in contact with the driving surface; and 3) a third mode, wherein the tracked-belt is raised above the driving surface during non-use. The tracked-belt may be automatically switchable into the second mode upon detection that the driving surface is slippery. Further, sensors may be provided for detecting that the driving surface is slippery.

In another embodiment of the disclosed technology, a method is used for providing additional traction and/or propulsion to a vehicle. The method may be carried out, not necessarily in the following order, by: a) measuring, using sensors, the difference in the speeds of a drive-shaft and the axle; b) deducing a level of friction between the tires and the road surface based on the measured difference; c) determining when the level of friction drops below a specified threshold; d) carrying out a step of extending based on the determination; e) extending a tracked-belt wheel assembly from an under-body of the vehicle, the tracked-belt wheel assembly having a circuitous tracked-belt disposed around at least two drive-wheels; f) engaging a road surface with the tracked-belt; pressing the tracked-belt against the road surface until a tire of the vehicle is raised above the road surface; and g) causing the tracked-belt to rotate against the road surface. Steps a) through d) are optional, and may be employed on some embodiments of the disclosed technology. Additionally, the step of extending may be carried out automatically upon detection that the road surface is slippery. Further, the extending may be controlled via a switch.

In yet another embodiment of the disclosed technology, a vehicle has: a) a drive-shaft; b) a first and a second axle; c) a differential unit coupling the drive-shaft with the first axle; d) an apparatus extendably affixed to the first axle via at least one hydraulic cylinder; and/or e) a drive-arm. The apparatus has a tracked-belt extended around at least two drive-wheels. The drive-arm extends between at least one of the drive-wheel and the differential unit for causing the tracked-belt to rotate. “Commensurate” for purposes of this disclose is defined as “at substantially the same speed and height” and “substantially” is defined as “within a 5% tolerance or a tolerance level allowed in the art.”

In a further embodiment of the disclosed vehicle, the apparatus may have three positions: 1) a first position, wherein the tracked-belt is pressed sufficiently against a driving surface, such that forward motion of the vehicle is halted; 2) a second position wherein the tracked-belt is engaged to the driving surface, such that the tire is still in contact with the driving surface; and 3) a third position wherein the tracked-belt is raised above the driving surface during non-use. In a further embodiment, the tracked-belt accelerates during normal driving to match a speed of the vehicle. This is carried out in order to engage the tracked-belt to the road surface immediately when needed or on command. The tracked-belt may be needed if the vehicle suddenly encounters a slippery or uneven road surface. Further, the tracked-belt may be pre-accelerated in order to provide additional braking in a time of need, or to provide an alternative driving mechanism in the event of a sudden flat tire.

It should be understood that the use of “and/or” is defined inclusively, such that the term “a and/or b” should be read to include the sets: “a and b,” “a or b,” “a,” “b.” Further details are set forth in the detailed description below.

### BRIEF DESCRIPTION OF THE DRAWINGS

FIG. 1 shows a stand-alone perspective view of a tracked-belt assembly with a single hydraulic cylinder, in accordance with an embodiment of the disclosed technology.

FIG. 2 shows a stand-alone perspective view of a tracked-belt assembly with two hydraulic cylinders, in accordance with an embodiment of the disclosed technology.

FIG. 3 shows a perspective view of a tracked-belt assembly installed on an axis of a vehicle, in accordance with an embodiment of the disclosed technology.

FIG. 4 shows the tracked-belt assembly of FIG. 3, with the addition of a drive-arm, in accordance with an embodiment of the disclosed technology.

FIG. 5 shows an elevation view of a tracked-belt assembly, with a single hydraulic cylinder installed on an axis of a vehicle, in accordance with an embodiment of the disclosed technology.

FIG. 6 shows an elevation view of a tracked-belt assembly, with two hydraulic cylinders in a first operating position, in accordance with an embodiment of the disclosed technology.

FIG. 7 shows the tracked-belt assembly of FIG. 6 in a second operating position, in accordance with an embodiment of the disclosed technology.

FIG. 8 shows the tracked-belt assembly of FIG. 6 in a third operating position, in accordance with an embodiment of the disclosed technology.

FIG. 9 shows a front elevation view of a pair of tracked-belt assemblies used on a vehicle, in accordance with an embodiment of the disclosed technology.

FIG. 10 shows a stand-alone perspective view of a tracked-belt assembly with additional drive wheels, in accordance with an embodiment of the disclosed technology.

FIG. 11 is a high level block diagram of a processing device that may be used to carry out an embodiment of the disclosed technology.

### DETAILED DESCRIPTION OF EMBODIMENTS OF THE DISCLOSED TECHNOLOGY

Embodiments of the disclosed technology are directed to methods and/or apparatuses for propelling a vehicle over difficult terrain, using a tracked-belt wheel assembly that is adjustably extendable from an under body of the vehicle. The tracked-belt wheel assembly may be driven by the same rotational force used to turn the drive-axle of the vehicle. A switch-controlled actuating feature may be used to raise and/or lower the wheel assembly, using one or more hydraulic cylinders. The switch may toggle between different operating modes of the wheel assembly which correspond to different levels of extension with respect to the driving surface and/or the tires of the vehicle. The tracked-belt may additionally have adjustable spikes or studs for further engaging a driving surface.

Embodiments of the disclosed technology will become clearer in view of the following description of the figures.

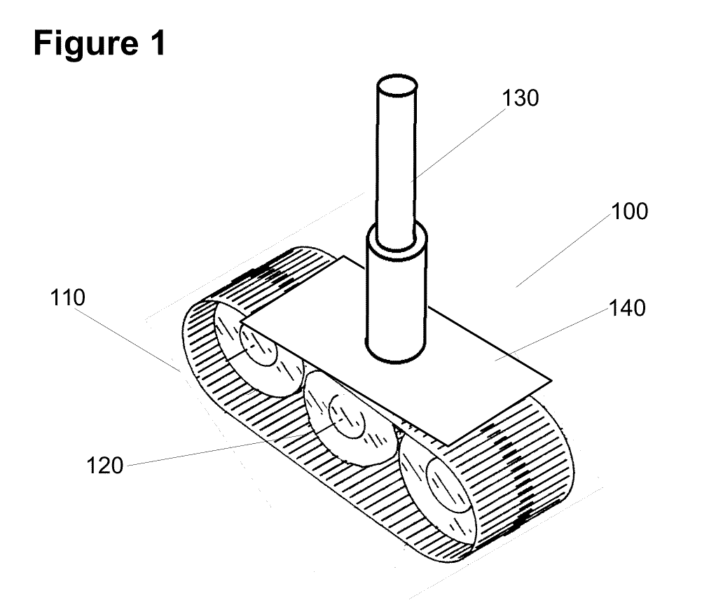

FIG. 1 shows a stand-alone perspective view of a tracked-belt assembly with a single hydraulic cylinder, in accordance with an embodiment of the disclosed technology. The tracked-belt assembly 100 is generally composed of a circuitous belt-track 110 disposed around at least two drive-wheels 120. The drive-wheels 120 are mounted on a mounting plate 140. A hydraulic cylinder 130 is affixed to, and extends upward from, a top surface of the mounting plate 140. Generally, for purposes of this specification, the “top” of the tracked-belt assembly 100 is the portion with the hydraulic cylinder 130 extending therefrom. Further, the “bottom” is the portion of the tracked-belt assembly 100 where the belt track 110 will abut the ground.

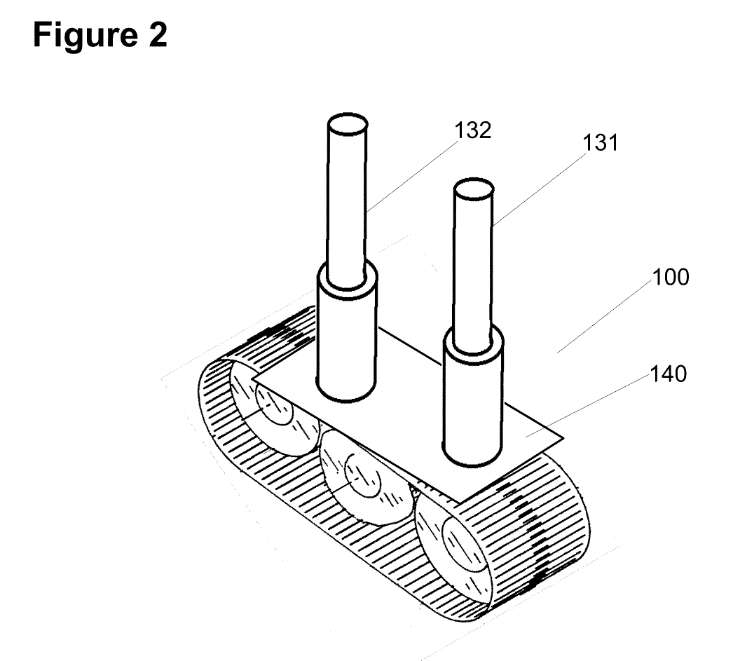

FIG. 2 shows a stand-alone perspective view of a tracked-belt assembly with two hydraulic cylinders, in accordance with an embodiment of the disclosed technology. In this embodiment, a first hydraulic cylinder 131 and a second hydraulic cylinder 132 extend from the mounting plate 140. The hydraulic cylinders 131 and 132 are mechanical actuators which are powered from pressurized hydraulic fluid, such as oil. The hydraulic cylinders 131 and 132 have a cylinder barrel in which a piston connected to a piston rod moves up and down. The cylinder barrel is closed at one end and has the piston extending from the other end. Fluid is pumped or injected into and/or out of the cylinder, in order to raise and/or lower the piston. As the piston is raised, the length of the hydraulic cylinder is extended. As the piston is lowered, the length of the hydraulic cylinder is shortened.

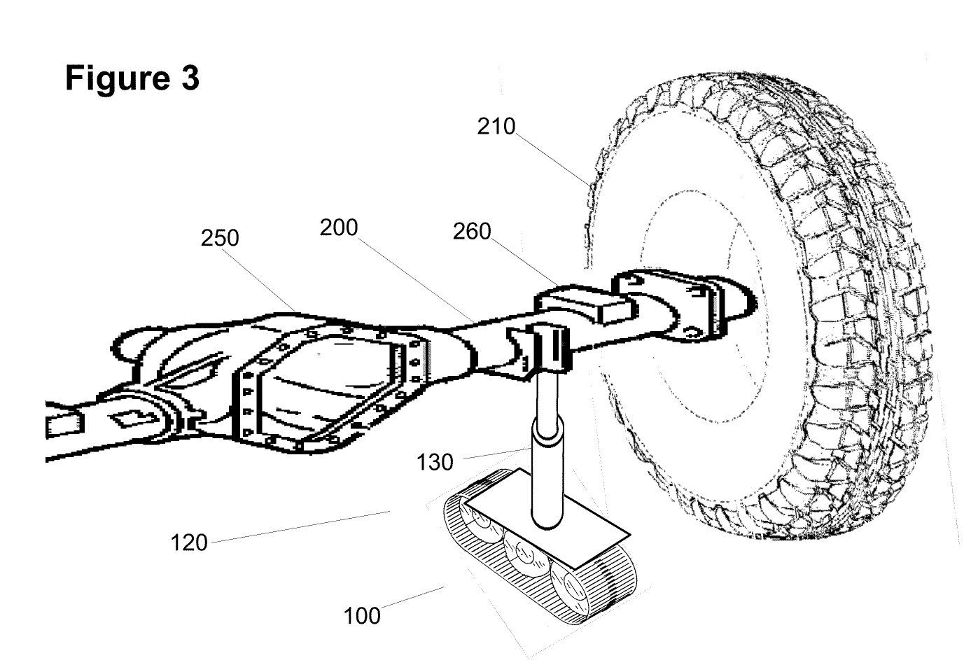

FIG. 3 shows a perspective view of a tracked-belt assembly installed on an axle of a vehicle, in accordance with an embodiment of the disclosed technology. The axle 200, of which only a portion is shown, may be the front or rear axle of a vehicle. Further, the tracked-belt assembly 100 may be installed to either the left or the right side of the axle 200. A differential unit 250 is shown disposed along the axle 200. The differential unit 250 is a gear train for translating and converting rotational motion. A tire 210 is mounted on the end of the axle 200. Generally, the tire 210 is driven by the translated rotational motion of the differential unit 250, which is typically driven by a drive-shaft (not shown).

The tracked-belt assembly 100 may be affixed via the hydraulic cylinder 130 to a portion of the axle 200. A fluid pump/tank unit 260 may also be disposed along the axle 200, or, alternatively, on the mounting plate 140. The tracked-belt assembly 100 is raised and lowered with respect to the axle 200. In embodiments, the hydraulic cylinder 130 may be angled or skewed towards the front or the back of the axle and vehicle. That is, the hydraulic cylinder 130 may not extend directly downward towards the ground, but, instead, may be angled, such that the tracked-belt assembly 100 resides in the front or back of the axle 200, and not just directly below the axle 200.

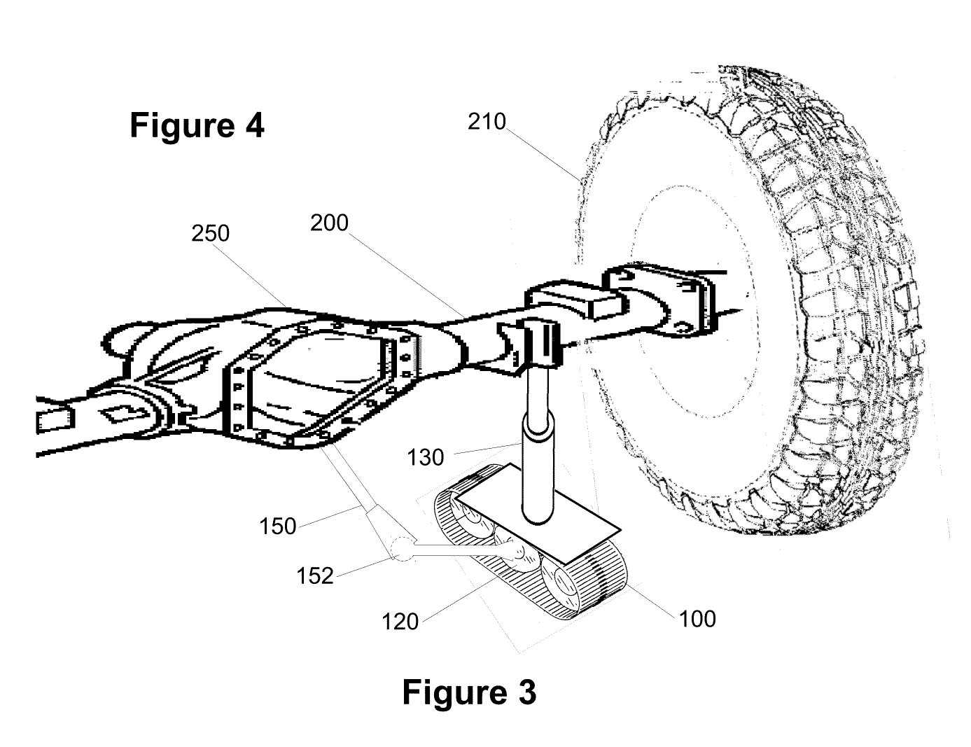

FIG. 4 shows the tracked-belt assembly of FIG. 3, with the addition of a drive-arm, in accordance with an embodiment of the disclosed technology. The drive-arm 150 extends from the differential unit 250, and may have one or more ball-and-joint bearings 152 for translating rotational and orthogonal motion. The drive arm 150 may be affixed to one or more of the drive-wheels 120 of the tracked-belt assembly 100. Thus, the drive-arm 150 may cause the rotation of the drive-wheels 120 and, in turn, the rotation of the belt-track 110. The movement and/or rotation of the drive-arm 150 may be powered by the differential unit 250. Thus, a gear, such as, for example, a bevel gear within the differential unit, may be affixed to the drive-arm 150 to cause the drive-arm to rotate. The ball-and-hinge joint 152 may be configured, such that the height of the tracked-belt assembly 100 may be adjusted, while the ability to rotate the drive arm 150 is maintained.

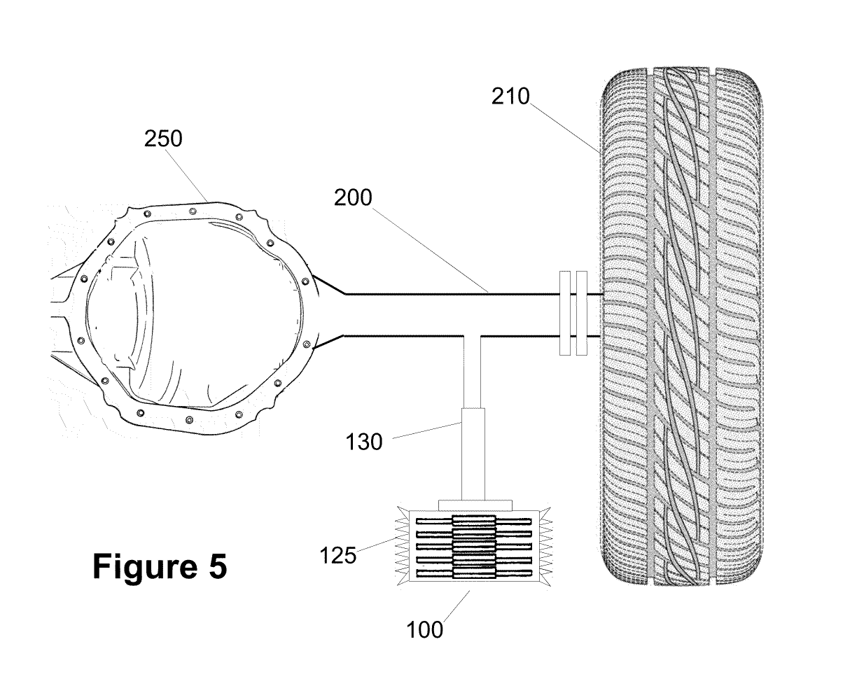

FIG. 5 shows an elevation view of a tracked-belt assembly with a single hydraulic cylinder installed on an axis of a vehicle, in accordance with an embodiment of the disclosed technology. As depicted, the tracked-belt assembly 100 is affixed to the 20 via the hydraulic cylinder 130. The hydraulic cylinder 130 may be permanently affixed to the axle 200 by way of welding. Laterally, one or more tracked-belt assemblies 100 may be disposed at any point(s) along the length of the axle 200. For example, in one embodiment, a single tracked-belt assembly 100 may extend directly from the differential unit 250, at the approximate center of the horizontal length of the axle 200. In another example, a tracked-belt assembly 100 may be positioned inches away from each tire of a four-wheeled vehicle. Also depicted in the embodiment shown in FIG. 5 are traction spikes 125 extending from the drive-wheels 120 and/or the belt track 110 of the tracked-belt assembly 100. The spikes 125 provide additional traction and/or stopping power. The spikes 125 also prevent lateral movement or slipping of the tracked-belt assembly 100.

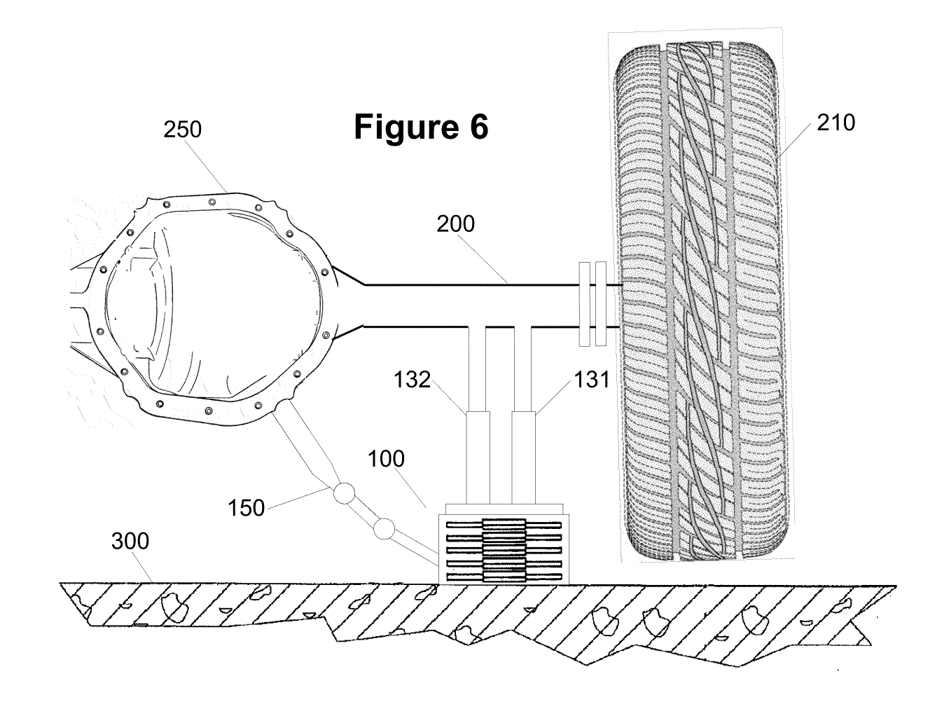

FIG. 6 shows an elevation view of a tracked-belt assembly with two hydraulic cylinders in a first operating position, in accordance with an embodiment of the disclosed technology. In the first operating position or mode, the tracked-belt assembly 100 is extended to abut and press against the ground with sufficient force to raise at least the tire 210 off of the ground 300. This position may be used to change a flat tire or to move the vehicle over an obstruction that is impassible by the tire 210.

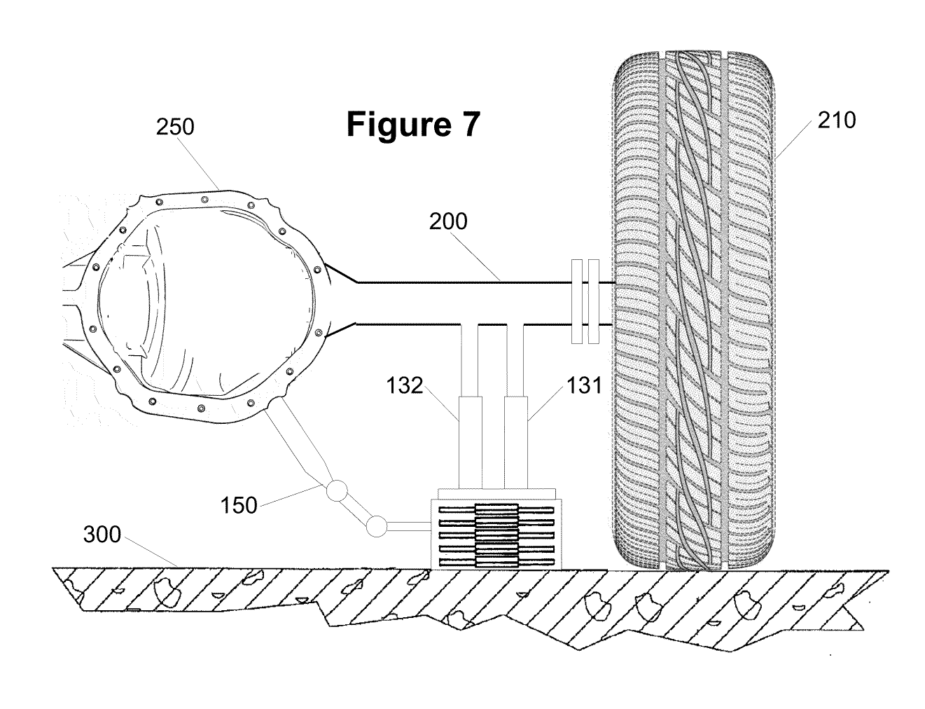

FIG. 7 shows the tracked-belt assembly of FIG. 6 in a second operating position, in accordance with an embodiment of the disclosed technology. In the second position, the tracked-belt assembly 100 is lowered, such that the bottom of the tracked-belt assembly 100 is at approximately the same elevation as the bottom of the tire 210 (i.e., the portion of the tire which abuts the driving surface 300). In this position, the tracked-belt assembly 100 may perform two different functions. The first function would be to provide additional propulsion and traction to the vehicle under slippery conditions. While carrying out this function, the drive-wheels 120 are rotated to cause the belt track 110 to rotate along the driving surface 300. Because the coefficient of friction between the tracked-belt assembly 100 and the driving surface 300 is much greater than the coefficient of friction between the tires and the driving surface, well-needed traction is provided during encounters with slippery surfaces. The second possible function for engaging the tracked-belt assembly 100 in the second position would be to provide additional braking support. In this embodiment, the belt track is locked and prevented from rotating. Therefore, the tracked-belt assembly 100 acts as a sort of hand-brake which may be engaged by a driver in order to brake under difficult driving conditions.

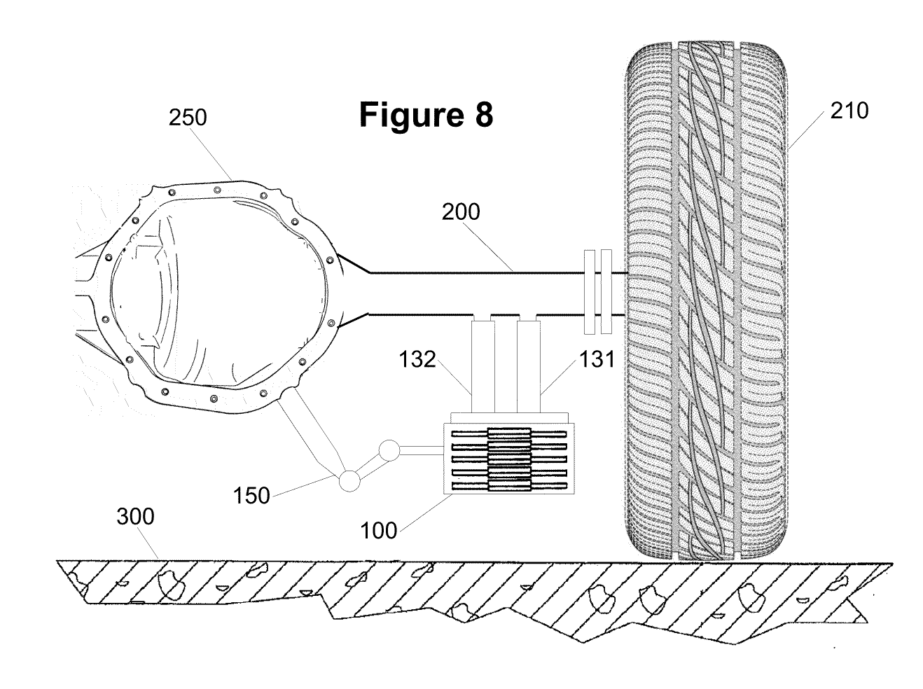

FIG. 8 shows the tracked-belt assembly of FIG. 6 in a third operating position. in accordance with an embodiment of the disclosed technology. In the third position, the tracked-belt assembly 100 is raised sufficiently off the driving surface 300 to render it unused. In this position, the tracked-belt assembly 100 is effectively “stored” and not visible. Thus, a vehicle employing the tracked-belt assembly 100 will appear just like any other vehicle, with no portion of the tracked-belt assembly visible.

It should further be understand that the present technology may be used in the event of a flat tire or failure of one of the wheels, such as loose bolts, low air pressure, or unbalanced tires. Upon detection of same, especially when the vehicle is traveling at high speed (for purposes of this disclosure, “greater than 50 kilometers per hour”), the track-belt assembly 100 is lowered to be just above ground level (defined as “within 15 cm of, but not touching the ground”) or to ground level (defined as “within 1 cm of or touching the ground”). The track wheel then engages with the ground as the situation worsens and the adjacent tire sinks lower and is kept there. As such, at high speed, the extra track wheel is already in place and ready to be engaged with the ground/may be engaged more quickly than if it is kept far above the ground (“greater than 15 cm”). Other conditions which may engage this lower position of the track wheel include sensing with sensors a slippery road, decreased traction, hazardous driving conditions and heavy braking.

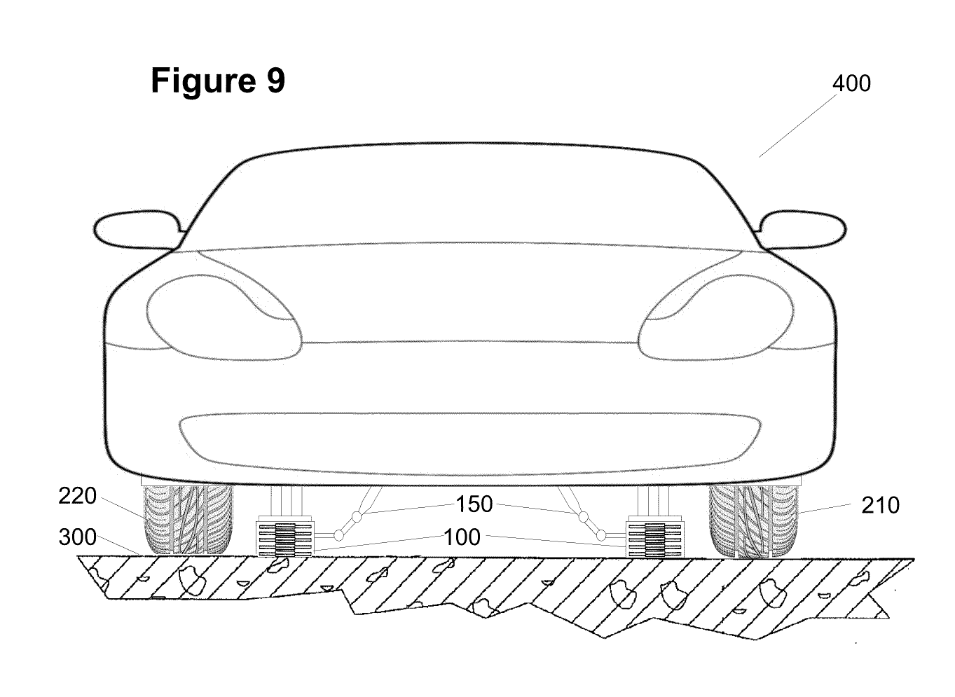

FIG. 9 shows a front elevation view of a pair of tracked-belt assemblies used on a vehicle, in accordance with an embodiment of the disclosed technology. In the embodiment depicted, a tracked-belt assembly is provided in close proximity to a left wheel 210 and a right wheel 220 of the vehicle 400. The tracked-belt assemblies 100 are depicted in the second operating position as described in FIG. 7. The respective drive-arms 150 and hydraulic cylinders are also visible due to the tracked-belt assemblies 100 being abutted to the driving surface 300.

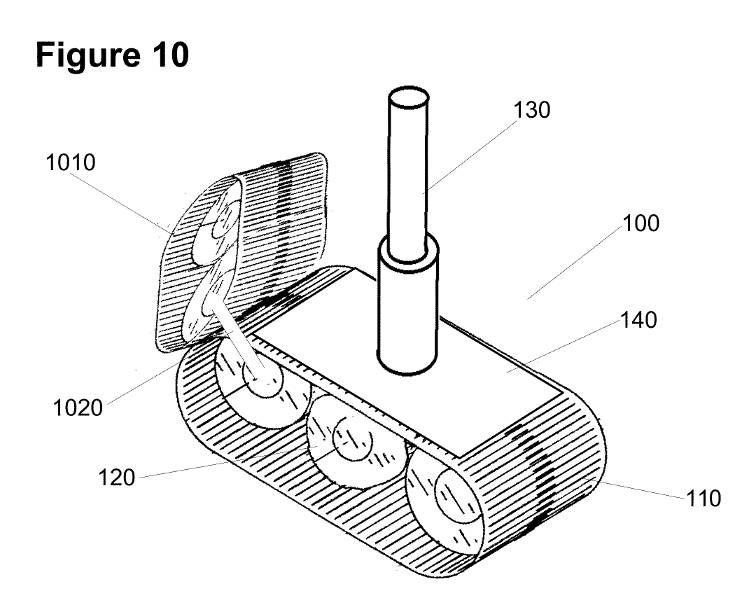

FIG. 10 shows a stand-alone perspective view of a tracked-belt assembly with additional drive wheels, in accordance with an embodiment of the disclosed technology. The additional drive wheels 1010 may be affixed to the front or the rear of the tracked-belt assembly 100. The additional drive wheels 1010 assist the vehicle in traversing an uneven road surface or terrain, such as, for example, a curb. The additional drive wheels 1010 may be powered by a connecting rod 1020, pulley or gear system in rotational communication with one of the drive wheels 120.

In still another embodiment of the disclosed technology, the tracked-belt assembly is coupled directly to a power steering system of the vehicle. In this embodiment, additional horizontal hydraulic cylinders run laterally between the tracked-belt and the arms of the power steering unit. Thus, as the wheels of the vehicle are turned, the tracked-belt assembly turns. In this embodiment, the tracked-belt is always parallel to the tire. As such, the tracked-belt may be used to steer the vehicle in the absence or failure of the power steering unit. The arms provide support and assist in turning the tracked-belt.

In a further embodiment, The differential arms are coupled to a bearing bolt. The bearing bolt is coupled to the hydraulic cylinders top base, positioned on the axle. Thus, as the power steering arms are turned, and the tires are caused to turn, then the tracked-belt assembly is in turn caused to turn. This embodiment may be carried out with respect to the front axle and the front tires of a vehicle. In the event of a tire failure, the power steering arms maintain control of the tracked-belt assembly and will steer the assembly.

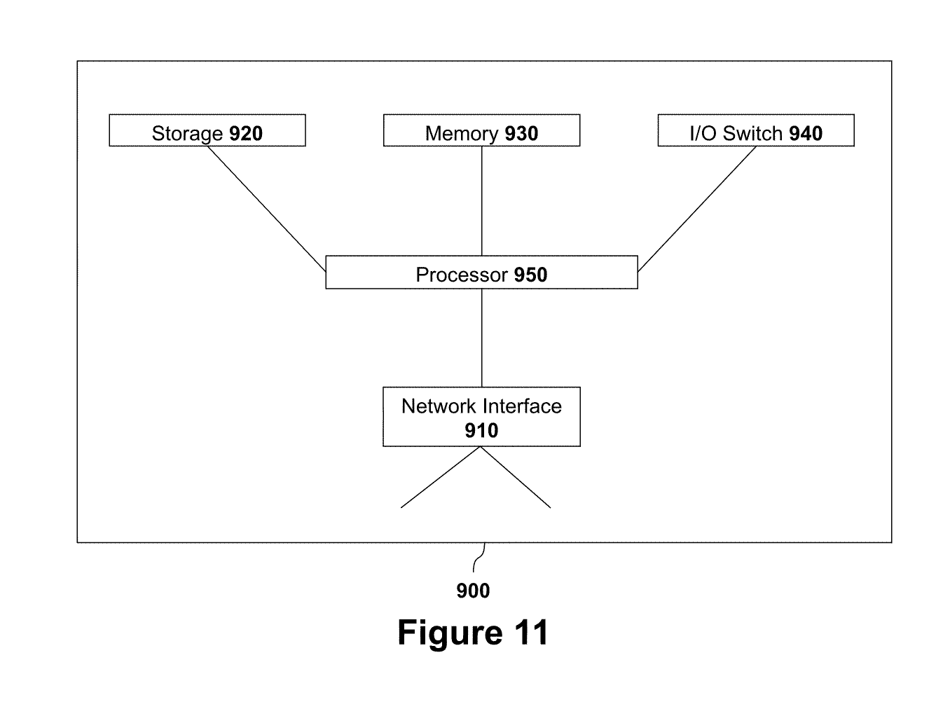

FIG. 11 is a high level block diagram of a processing device that may be used to carry out an embodiment of the disclosed technology. Device 900 comprises a processor 950 that controls the overall operation of the computer by executing the device's program instructions which define such operation. The device's program instructions may be stored in a storage device 920 (e.g., magnetic disk, database) and loaded into memory 930 when execution of the console's program instructions is desired. The device 900 may be or may be part of an on-board computer of a vehicle. Alternatively, the device 900 may be retrofitted to a vehicle and installed on any portion or location of the vehicle, including, but not limited to, under the hood, under the body, inside the cabin, inside the trunk, inside the engine compartment, etc.

Thus, the device's operation will be defined by the device's program instructions stored in memory 930 and/or storage 920, and the console will be controlled by the processor 950 executing the console's program instructions. A device 900 also includes one or more input network interfaces for communicating with other devices via a network (e.g., radio signaling). The device 900 further includes an electrical input interface for receiving power and data from a battery or other power source.

A device 900 also includes one or more output network interfaces 910 for communicating with other devices. Device 900 also includes an input/output switch 940, representing devices which allow for user interaction with the tracked-belt assembly 100 (e.g., buttons, controllers, levers, etc.). The input/output switch 940 may be disposed within the cabin of the vehicle, in order to facilitate use of the tracked-belt assembly 100 by a driver of the vehicle. One skilled in the art will recognize that an implementation of an actual device will contain other components as well, and that FIG. 9 is a high level representation of some of the components of such a device for illustrative purposes. It should also be understood by one skilled in the art that the methods and systems depicted in FIGS. 1 through 10 may be implemented on a device such as is shown in FIG. 11.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the disclosed technology.

I claim:

1. An apparatus for propelling a vehicle, said vehicle having at least one axle with a differential unit and tires disposed at ends thereof, said apparatus comprising:
a circuitous tracked-belt disposed around at least two drive-wheels;
at least one hydraulic cylinder extending between said drive-wheels and said axle of said vehicle, a length of said hydraulic cylinder being operatively adjustable to raise or lower said drive-wheels during said propelling of said vehicle; and
an adjustable drive-arm extending between said drive-wheels and said differential unit, wherein said drive-wheels are rotatable by translational rotational power provided by said differential unit.

2. The apparatus of claim 1, further comprising:
a second hydraulic cylinder extending horizontally between a power steering unit and said drive wheels.

3. The apparatus of claim 1, further comprising:
spikes extending from said drive-wheels.

4. The apparatus of claim 1, wherein said circuitous tracked-belt is disposed adjacent to said tire of said vehicle, such that lowering of said tracked-belt raises said tire off a driving surface.

6. The apparatus of claim 2, wherein said tracked-belt is switchable between three modes:
a first mode wherein said tracked-belt is pressed sufficiently against a driving surface, such that at least one said tire of said vehicle is lifted off said driving surface;
a second mode wherein said tracked-belt is engaged to said driving surface. such that said all tires of said vehicle are in contact with said driving surface; and
a third mode wherein said tracked-belt is raised above said driving surface.

7. The apparatus of claim 6, wherein said tracked-belt is automatically switched into said second mode upon detection of a decreased traction condition.

8. The apparatus of claim 7, further comprising sensors used for said detection that said driving surface is slippery.

9. The apparatus of claim 2, further comprising:
spikes that are extendable, using said switch, from said drive-wheels to engage a driving surface.

10. A method of providing additional traction and/or propulsion to a vehicle, the method comprising:
extending a tracked-belt wheel assembly from an under-body of said vehicle, said tracked-belt wheel assembly having a circuitous tracked-belt disposed around at least two drive-wheels;
engaging a road surface with said tracked-belt; and
causing said tracked-belt to rotate against said road surface.

11. The method of claim 10, wherein said tracked-belt wheel assembly is controlled via a switch accessible to a driver of said vehicle.

12. The method of claim 10, further comprising, before said step of causing, an additional step of:
pressing said tracked-belt against said road surface until a tire of said vehicle is raised above said road surface.

13. The method of claim 10, wherein said step of extending is carried out automatically upon detection that said road surface is slippery.

14. The method of claim 10, further comprising, before said step of extending, additional steps of:
measuring, using sensors, the difference in the speeds of a drive shaft and said axle;
deducing a level of friction between said tires and said road surface based on said measured difference;
determining when said level of friction drops below a specified threshold; and
carrying out said step of extending based on said determination.

15. The method of claim 10, wherein said tracked-belt rotates before said step of engaging said road surface.

16. The method of claim 10, wherein said tracked-belt rotation is based on depressing a brake pedal of said vehicle beyond a threshold.

17. The method of claim 15, wherein a speed of said rotated tracked-belt is equal to that of said vehicle prior to engaging said road surface.

18. The method of claim 15, wherein said tracked-belt accelerates during normal driving to match a speed of said vehicle, such that said tracked-belt may be engaged to said road surface immediately when needed.

19. The method of claim 15, wherein said tracked-belt is engaged to said driving surface when an anti-lock brake system on said vehicle is engaged.

20. The method of claim 15, wherein said rotation of said tracked-belt is commensurate with a rotation of tires of said vehicle.

21. A vehicle comprising:
a drive-shaft;
a first and a second axle;
a differential unit coupling said drive-shaft with said first axle;
an apparatus extendably affixed to said first axle via at least one hydraulic cylinder, said apparatus having a track-belt extended around at least two drive-wheels; and
a drive-arm extending between at least one said drive-wheel and said differential unit for causing said tracked-belt to rotate;
wherein said tracked-belt drops to a driving surface upon heavy braking of vehicle and/or detection of a hazardous condition.

22. The vehicle of claim 21, wherein said tracked-belt rotates prior to dropping to a driving surface.

23. The vehicle of claim 21, wherein said apparatus has three positions:
a first position wherein said tracked-belt is pressed sufficiently against a driving surface, such that forward motion of the vehicle is halted;
a second position wherein said tracked-belt is engaged to said driving surface, such that said tire is still in contact with said driving surface; and
a third position wherein said tracked-belt is raised above said driving surface while not in use.

24. The vehicle of claim 21, wherein said hazardous condition is a flat tire and said tracked-belt drops to just above the road surface, and touches said road surface as said flat tire loses more air.
